(19) United States
(12) Patent Application Publication
(10) Pub. No.: US 2024/0422276 A1
(43) Pub. Date: Dec. 19, 2024

(54) PROCESSING APPARATUS, IMAGE PROCESSING APPARATUS, AND IMPORT DATA PROCESSING METHOD

(71) Applicant: SHARP KABUSHIKI KAISHA, Sakai City (JP)

(72) Inventor: Tatsuya WATABE, Sakai City (JP)

(21) Appl. No.: 18/742,555

(22) Filed: Jun. 13, 2024

(30) Foreign Application Priority Data
Jun. 16, 2023 (JP) 2023-098905

(51) Int. Cl. H04N 1/00; H04N 1/44

(52) U.S. Cl. CPC H04N 1/00973; H04N 1/0097; H04N 1/4426; H04N 1/4433; H04N 2201/0094

(57) ABSTRACT

A processing apparatus includes: one or more memories that store an apparatus setting including authentication information; and one or more controllers that verify import data imported to an apparatus and collectively rewrite, with the import data, the apparatus setting stored in the one or more memories, where as a result of the verification of the import data, when it is determined that the import data includes a related setting relating to an authentication method requiring prior authorization, and that the related setting corresponds to the authentication information, the one or more controllers reset an authentication setting by controlling rewriting of the authentication information with the related setting.

### BACKGROUND OF THE INVENTION

### Field of the Invention

The present disclosure relates to a processing apparatus, and the like.

### Description of the Background Art

Such technology is known by which, apparatus settings exported from another apparatus are imported as import data to generate a duplication of an apparatus having the same apparatus settings as the other apparatus, or apparatus settings exported from the apparatus itself are imported to recover (restore) the apparatus settings (hereinafter occasionally referred to as device cloning).

For example, in the case of a multifunction machine, having a function as a processing apparatus, export data includes apparatus settings such as setting information for executing a job under each mode such as copy, print, scan, facsimile, or e-mail transmission/reception, history information, and user information of a user who uses the multifunction machine. The export data further includes authentication information for providers providing e-mail, photo, video storage or distribution services. The export data is imported to a target multifunction machine as import data, thereby enabling to collectively rewriting the existing apparatus settings retained in the multifunction machine, including the authentication information.

Regarding importing of apparatus settings including authentication information, for use in a case where an information processing apparatus, which uses a cloud service requiring OAuth 2.0 (hereinafter simply referred to as “OAuth authentication”) as an authentication method, imports export file exported from an other information processing apparatus which uses the same cloud service, a technique is known by which data read from the export file is stored in the state of including a token and the token is used in authentication when the same cloud service is used.

The present disclosure has an objective to provide a processing apparatus which, even when importing import data which includes related information relating to an authentication method requiring prior authorization, is capable of easily resetting authentication settings regarding that authentication method.

### SUMMARY OF THE INVENTION

So as to solve the above-stated problem, a processing apparatus according to the present disclosure includes: one or more memories that store an apparatus setting including authentication information; and one or more controllers that verify import data imported to an apparatus and collectively rewrite, with the import data, the apparatus setting stored in the one or more memories, where as a result of the verification of the import data, when it is determined that the import data includes a related setting relating to an authentication method requiring prior authorization, and that the related setting corresponds to the authentication information, the one or more controllers reset an authentication setting by controlling rewriting of the authentication information with the related setting.

In addition, an image processing apparatus according to the present disclosure includes a processing apparatus including one or more memories that store an apparatus setting including authentication information; and one or more controllers that verify import data imported to an apparatus and collectively rewrite, with the import data, the apparatus setting stored in the one or more memories, where as a result of the verification of the import data, when it is determined that the import data includes a related setting relating to an authentication method requiring prior authorization, and that the related setting corresponds to the authentication information, the one or more controllers reset an authentication setting by controlling rewriting of the authentication information with the related setting; and an image processor that performs image processing, on the basis of the apparatus setting rewritten with the import data.

In addition, an import data processing method according to the present disclosure includes storing an apparatus setting including authentication information; verifying import data imported to an apparatus and collectively rewriting, with the import data, the apparatus setting having been stored; and as a result of the verification of the import data, when it is determined that the import data includes a related setting relating to an authentication method requiring prior authorization, and that the related setting corresponds to the authentication information, resetting an authentication setting by controlling rewriting of the authentication information with the related setting.

The present disclosure is able to provide a processing apparatus which, even when importing import data which includes related information relating to an authentication method requiring prior authorization, is capable of easily resetting authentication settings regarding that authentication method.

### BRIEF DESCRIPTION OF THE DRAWINGS

FIG. 1 is a diagram for explaining an example of a connection state of a multifunction machine, a terminal apparatus, and a cloud server.

FIG. 2 is a functional configuration diagram of the multifunction machine.

FIG. 3 is a functional configuration diagram of the terminal apparatus.

FIG. 4 is a flowchart for explaining a flow of processing according to a first embodiment.

FIG. 5 is a diagram for explaining a configuration example of export data.

FIG. 6 is a flowchart for explaining a flow of processing according to the first embodiment.

FIG. 7 is a flowchart for explaining a flow of processing according to the first embodiment.

FIG. 8 is a flowchart for explaining a flow of processing according to the first embodiment.

FIG. 9 is a flowchart for explaining a flow of processing according to the first embodiment.

FIG. 10 is a flowchart for explaining a flow of processing according to the first embodiment.

FIG. 11 is a diagram for explaining an operation example according to the first embodiment.

FIG. 12 is a diagram for explaining an operation example according to the first embodiment.

FIG. 13 is a diagram for explaining an operation example according to the first embodiment.

FIG. 14 is a diagram for explaining an operation example according to the first embodiment.

FIG. 15 is a diagram for explaining an operation example according to a second embodiment.

FIG. 16 is a flowchart for explaining a flow of processing according to a third embodiment.

FIG. 17 is a diagram for explaining an operation example according to the third embodiment.

FIG. 18 is a diagram for explaining a difference between an SMTP authentication method and an OAuth authentication method in SMTP settings.

### DESCRIPTION OF THE PREFERRED EMBODIMENTS

Hereinafter, the embodiments of the present disclosure are described with reference to the drawings. It should be noted that the following embodiments are examples for explaining the present disclosure, and the technical content of the explanation recited in the scope of claims is not limited to the following disclosure.

So as to execute e-mail transmission/reception of jobs in an image processing apparatus such as a multifunction machine, authentication with respect to an e-mail server such as a simple mail transfer protocol (SMTP) server is required, for example. In recent years, authentication methods requiring prior authorization, such as OAuth authentication, are becoming mainstream, as securer authentication methods.

OAuth authentication is a technique to give permission to an authorized service with respect to usage of resources, thereby to perform authentication with an e-mail server by using the token obtained as a result of the permission.

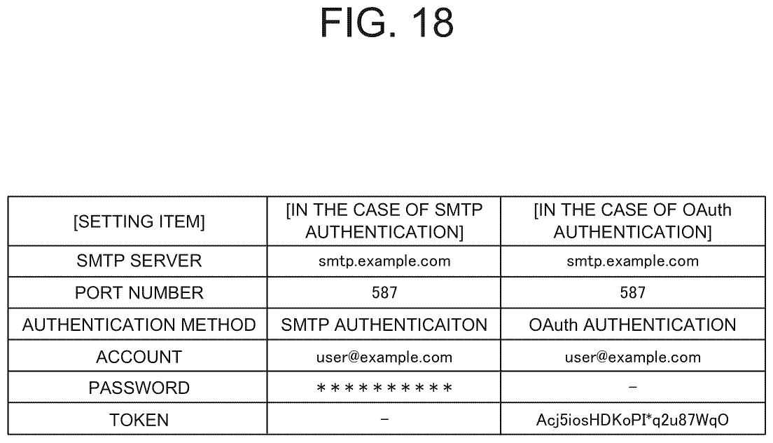

By the way, if the authentication method of authentication information to be imported by device cloning is SMTP authentication, resetting of authentication settings completes by rewriting the existing apparatus settings with the imported authentication information, such as password. Here, as illustrated in FIG. 18, the only differences between the case where the authentication method is SMTP authentication and the case where the authentication method is OAuth authentication are the authentication methods and whether to set a password or a token. However, if the authentication method is OAuth authentication, import (export) of a token is prohibited in normal operations, and the token is not included in the import data. So as to reset the authentication settings in the import destination, permission from the holder of the imported authentication information (account), the apparatus manager, or the like, is required.

In the case where the authentication method of the authentication information included in the import data in the device cloning is OAuth authentication, it is likely that those users who are accustomed to the operations using authentication information, such as password, are not aware that permission is required for obtaining (usage) of the token.

Moreover, if OAuth authentication is already applied, as the authentication method, in the apparatus which is the import destination of the import data, the existing authentication information may be inadvertently rewritten with the authentication information other than the imported token having been imported by device cloning. Once such inadvertent rewriting (overwriting) of the authentication information occurs, the authentication settings cannot be easily restored to the original state unlike the case of passwords, and the permission from the apparatus manager, or the like, is required therefor, which is troublesome and inconvenient.

In the following embodiments, the present disclosure realizes a processing apparatus which, even when importing import data which includes related information relating to an authentication method requiring prior authorization, is capable of easily resetting authentication settings regarding that authentication method.

### 1. First Embodiment

### 1.1. Entire Configuration

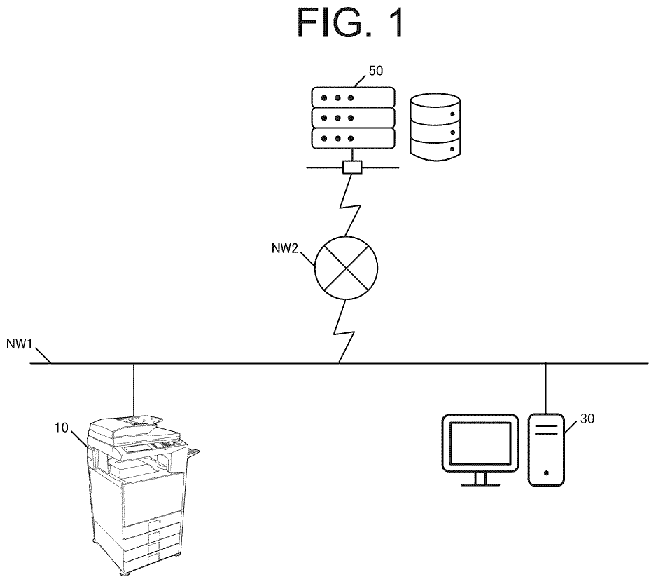

FIG. 1 is a diagram for explaining an example of a connection state of a multifunction machine 10, which implements a processing apparatus according to a first embodiment, a terminal apparatus 30, and a cloud server 50.

The multifunction machine 10 according to the first embodiment is an image processing apparatus that is capable of realizing, in a single housing, a job under each mode such as copy, print, scan, facsimile or e-mail transmission/reception. In the present disclosure, the multifunction machine 10 is explained as an embodiment of the image processing apparatus. However, any embodiment of the image processing apparatus can be unlimitedly used, as long as it includes the processing apparatus according to the present disclosure and having an image processing function, and such an image processing apparatus as a copier, a printer, and a facsimile machine, other than the multifunction machine 10, may also be used. The multifunction machine 10 is an image processing apparatus whose apparatus settings can reflect the export data transmitted from the terminal apparatus 30, as import data.

The multifunction machine 10 is connected to the terminal apparatus 30 and to the cloud server 50, via networks NW1 and NW2. The multifunction machine 10 is configured to communicate with the terminal apparatus 30 and with the cloud server 50, by a communication protocol such as a hyper transfer protocol (HTTP). Note that the networks NW1 and NW2 are not particularly limited, as long as they are among such network lines as a local area network (LAN), a wide area network (WAN), the Internet, a telephone line, and a facsimile line. Note that the multifunction machine 10 can use a service provided by the cloud server 50, on the basis of the token obtained from the cloud server 50.

The terminal apparatus 30 can be configured as a personal computer (PC) which is used by a user who uses a cloud service provided by the cloud server 50. Examples of the terminal apparatus 30 include, other than a PC of a desktop type, such mobile terminal apparatuses as a notebook computer, a smartphone, a tablet computer, and a portable telephone. The configuration of the terminal apparatus 30 is not particularly limited as long as the terminal apparatus 30 is under an environment communicable with the multifunction machine 10 and the cloud server 50. In addition, the terminal apparatus 30 can perform processing relating to device cloning via a web page provided by the multifunction machine 10, such as importing of export data output from an other image processing apparatus, not illustrated in the drawings, etc., and exporting of apparatus settings from the multifunction machine 10.

The cloud server 50 is a server of a provider providing e-mail, photo, video storage or distribution services. The cloud server 50 complies with an OAuth authentication method, for example, which is an authentication method requiring prior authorization. The cloud server 50 can function as an authorization server that gives permission to usage of resources by performing an authorization code flow based on the OAuth authorization. The configuration of the cloud server 50 is not particularly limited as long as it is able to generate an authorization code, a token, or the like, depending on whether the authorization succeeds or not.

### 1.2. Functional Configuration

### 1.2.1. Multifunction Machine 10

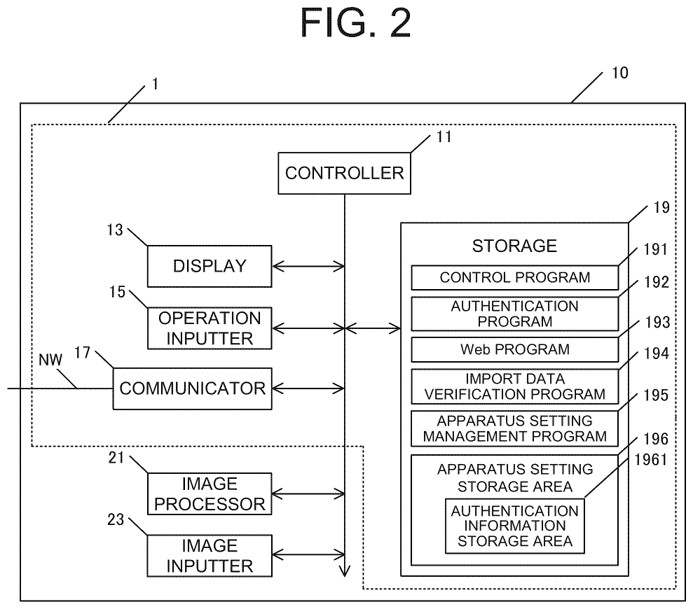

A functional configuration of the multifunction machine 10 according to the first embodiment is described. FIG. 2 is a functional configuration diagram of the multifunction machine 10. The multifunction machine 10 includes, in addition to the configuration of the processing apparatus 1 represented by a dotted frame in the drawing, an image processor 21 and an image inputter 23.

A controller 11 controls the entire multifunction machine 10. The controller 11 may be configured by one or more arithmetic units (central processing units (CPU) or the like), for example. The controller 11 realizes its functions by reading various types of programs stored in a storage 19 and executing the programs.

A display 13 displays various types of information to a user, or the like. The display 13 can be configured by a liquid crystal display (LCD), an organic electro-luminescence (organic EL) display, or the like, for example. The display 13 can display a screen based on screen information for browsing purposes, which is generated by a later-described web program 193.

An operation inputter 15 receives input of information by a user, or the like. The operation inputter 15 can be configured by various types of inputting apparatuses, including an operation key, such as a hard key and a software key, and a button, etc. Note that the operation inputter 15 can be configured as a touch panel to which inputting is possible via the display 13. In this case, as an inputting method for a touch panel, such general methods can be adopted, as a resistive membrane method, an infrared ray method, an electromagnetic induction method, and a capacitive sensing method.

A communicator 17 includes either a wired or wireless interface or both wired and wireless interfaces, for communicating with other apparatuses (the terminal apparatus 30, the cloud server 50, etc.) via the network NW1, NW2, such as the LAN, WAN, Internet, telephone line, or facsimile line, for example. In addition, the communicator 17 may include interfaces relating to (short-range) wireless communication technologies such as Bluetooth (registered trademark), near field communication (NFC), Wi-Fi (registered trademark), ZigBee (registered trademark), Irda, wireless USB, or the like.

The storage 19 stores various types of programs and various types of data, which are required to operate the multifunction machine 10. The storage 19 may be configured by storage devices, such as random access memory (RAM), hard disk drive (HDD), solid state drive (SSD), and read only memory (ROM).

In the first embodiment, the storage 19 stores therein a control program 191, an authentication program 192, a web program 193, an import data verification program 194, and an apparatus setting management program 195, and secures an apparatus setting storage area 196.

The control program 191 is a program read by the controller 11 for general control of the multifunction machine 10. The controller 11, having read the control program 191, controls driving of the display 13, the operation inputter 15, the communicator 17, and the like, to play the function of the processing apparatus 1 according to the present disclosure, and further controls driving of the image processor 21 and the image inputter 23, to perform setting, executing, post-processing, etc. of each job of copy, print, scan, facsimile, or e-mail transmission/reception, etc.

The authentication program 192 is a program read by the controller 11 for authentication processing with the cloud server 50. The controller 11, having read the authentication program 192, can perform authentication processing (SMTP authentication method, POP authentication method, or the like) which performs authentication by a combination of a user name (user ID) and a password, for example, in addition to such an authentication method as the OAuth authentication.

The web program 193 includes a browser program and a server program. The controller 11, having read the browser program, functions as a web browser, to render contents, input of which is received from the cloud server 50 or the terminal apparatus 30, thereby generating screen information for browsing purposes. In addition, the controller 11, having read the browser program, performs communication with the cloud server 50 regarding authentication processing, or with the terminal apparatus 30 regarding device cloning, or the like. The controller 11, having read the server program, functions as a print server, to save, share, and output the received print data (including print data facsimile transmission and transmission of print data attached to electric mail). In addition, the controller 11, having read the server program, can receive export data transmitted from the terminal apparatus 30 via a web page.

The import data verification program 194 is a program read by the controller 11 for importing the export data received via the web page, as import data. The controller 11, having read the import data verification program 194, verifies the import data, determines whether the import data satisfies the requirement of the device cloning, and determines which apparatus setting the decoded setting value relates to.

The apparatus setting management program 195 is a program read by the controller 11 for managing the apparatus setting of the multifunction machine 10, such as setting information for executing a job under each mode such as copy, print, scan, facsimile, or e-mail transmission/reception, history information, user information of a user who uses the multifunction machine 10, and authentication information for the cloud server 50. The controller 11, having read the apparatus setting management program 195, manages the apparatus setting, for example by performing rewriting, writing, updating, deletion, etc. of the setting value for the existing apparatus setting managed in the apparatus setting storage area 196, based on the verification result of the import data. In particular, when the controller 11, having read the apparatus setting management program 195, determines that the import data includes related setting which relates to an authentication method requiring prior authorization, such as OAuth authentication (hereinafter occasionally referred to as “OAuth authentication information”), and that the OAuth authentication information is information corresponding to authentication information relating to the existing apparatus setting in the multifunction machine 10 (hereinafter occasionally referred to as “authentication information”), then the controller 11 controls rewriting of the apparatus authentication information by means of the OAuth authentication information, thereby resetting the authentication setting. Here, as illustrated in the example in FIG. 18, the related setting which relates to OAuth authentication is assumed to represent such authentication information relating to the OAuth authentication, as a SMTP server (name), a port number, an authentication method, or an account, excluding the token.

The apparatus setting storage area 196 is a storage area for storing the apparatus setting of the multifunction machine 10. The apparatus setting storage area 196 includes a storage area for storing setting information for executing a job under each mode such as copy, print, scan, facsimile, or e-mail transmission/reception, history information, user management information of a user who uses the multifunction machine 10, and other apparatus settings. The apparatus setting storage area 196 also includes an authentication information storage area 1961 for storing authentication information for the cloud server 50. If an OAuth authentication method is set as the authentication method for the multifunction machine 10, the authentication information storage area 1961 stores the authentication method (OAuth authentication), account name, server information, token, or the like, as the apparatus authentication information. In addition, if an SMTP authentication method is set as the authentication method, the authentication information storage area 1961 stores the authentication method (SMTP authentication), account name, password, server information, or the like, as the apparatus authentication information. Note that the authentication information storage area 1961 may store authentication information relating to log-in authentication for the multifunction machine 10, or the like, and authentication information storage area 1961 can be provided in another storage device, not illustrated, outside the multifunction machine 10.

The image processor 21 forms an image based on the generated image data or the input print data, on a sheet of paper, or the like, as a recording medium. The image processor 21 feeds a sheet of paper from a paper feed tray, not illustrated, forms an image based on the image data on the sheet of paper, and thereafter discharges the sheet of paper to a paper discharger, not illustrated. The image processor 21 can be configured by an electrophotographic laser printer, or the like. In this case, the image processor 21 forms an image using toner(s) supplied from toner cartridge(s), not illustrated, corresponding to toner color(s) (e.g., cyan, magenta, yellow, black). In addition, such an embodiment of the image processor 21 is possible in which the image processor 21 performs shading compensation, density correction, or the like, on the image data input from the image inputter 23, thereby generating image data for output for image transmission purposes.

The image inputter 23 scans a document to generate image data. The image inputter 23 includes an image sensor such as a charge coupled device (CCD), a contact image sensor (CIS), or the like, and may be configured as a scanner apparatus that includes an automatic document feeder (ADF), a flatbed to place a document thereon for reading the document, or the like. The configuration of the image inputter 23 is not particularly limited as long as it is able to generate image data by reading an image of light reflected from a document image by means of an image sensor. Note that the image inputter 23 may also be configured as an interface capable of obtaining print data stored in a portable storage medium such as a universal serial bus (USB) memory or print data transmitted from an external apparatus, not illustrated.

### 1.2.2. Terminal Apparatus 30

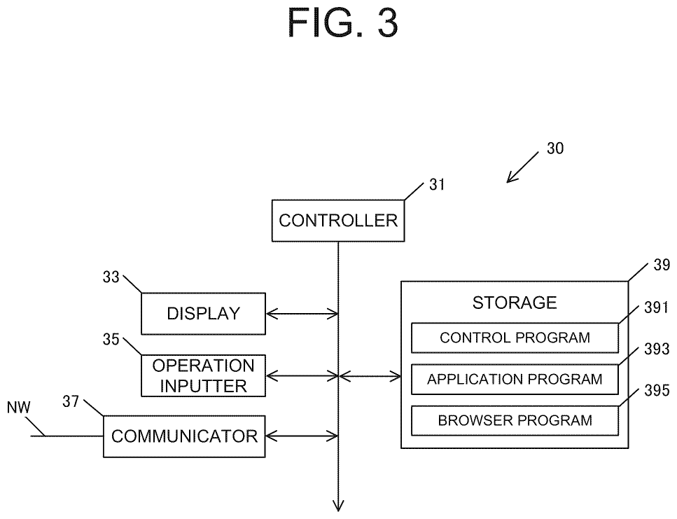

FIG. 3 is a functional configuration diagram of the terminal apparatus 30. The terminal apparatus 30 includes a controller 31, a display 33, an operation inputter 35, a communicator 37, and a storage 39.

The controller 31 controls the entire terminal apparatus 30. For example, the controller 31 is configured by one or more arithmetic units (CPU, or the like). The controller 31 realizes its functions by reading various types of programs stored in the storage 39 and executing the programs.

The display 33 displays various types of information to a user, or the like. The display 33 can be configured by a display apparatus such as an LCD or an organic EL display. The display 33 can display a screen based on the screen information for browsing purposes generated by a later-described browser program 395, under control by the controller 31.

The operation inputter 35 receives input of information by a user, or the like. The operation inputter 35 can be configured by various types of inputting apparatuses, including a keyboard, such as a hard key and a software key, a mouse, a track ball, a touch pad, and a touch panel, etc.

The communicator 37 includes either a wired or wireless interface or both wired and wireless interfaces, for communicating with other apparatuses (the multifunction machine 10, the cloud server 50, etc.) via a network (NW), such as the LAN, WAN, Internet, telephone line, or facsimile line, for example. In addition, the communicator 37 may include interfaces relating to (short-range) wireless communication technologies such as Bluetooth (registered trademark), NFC, Wi-Fi (registered trademark), ZigBee (registered trademark), Irda, wireless USB, or the like.

In the first embodiment, the storage 39 stores a control program 391, an application program 393, and a browser program 395.

The control program 391 is a program read by the controller 31 for general control of the terminal apparatus 30. The controller 31, having read the control program 391, controls driving of the display 33, the operation inputter 35, the communicator 37, and the like, to play the function of the terminal apparatus 30.

The application program 393 is a program read by the controller 31 upon receiving an activation instruction by a user. The controller 31, having read the application program 393, provides a specific function according to a purpose of the user, such as document creation, graphic drawing, Internet browsing, etc., for example. The application program 393 is obtainable by being installed via a recording medium such as a CD, a DVD, etc., or by being downloaded from an application providing service, not illustrated. In addition, the application may include a program to realize device cloning as its function. The controller 31, having read the program to realize the device cloning, may obtain export data from an other image processing apparatus, not illustrated, or from the multifunction machine 10, or may give such instructions to the multifunction machine 10 to transmit, import, etc. the obtained export data.

The browser program 395 is a program read by the controller 31 for generating screen information for browsing purposes, by rendering contents, input of which is received from the multifunction machine 10, the cloud server 50, or the like. The controller 31, having read the browser program 395, functions as a web browser, to communicate with the multifunction machine 10 or the cloud server 50.

### 1.2.3. Cloud Server 50

The cloud server 50 can have a known configuration which complies with an OAuth authentication method or an SMTP authentication method, and which can provide storage or distribution services of e-mail, photo, video, etc., depending on success or failure of the result of authentication according to the obtained authentication (authorization) information, such as user name (user ID), password, or token. Therefore, description of the functional configuration of the cloud server 50 is omitted.

### 1.3. Flow of Processing

### 1.3.1. Export Processing

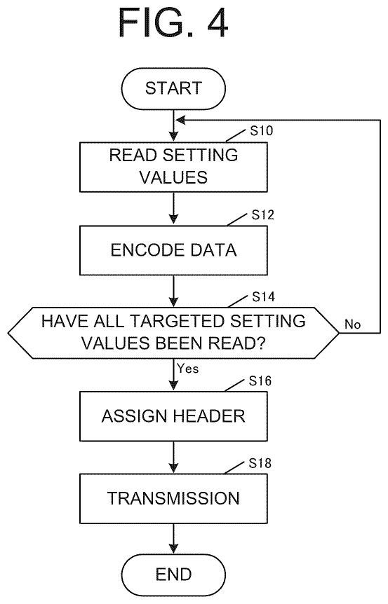

Next, a flow of processing according to the first embodiment is described. First, export processing of an apparatus setting is described with reference to a flowchart in FIG. 4. The processing described with reference to FIG. 4 is processing performed by an other image processing apparatus, not illustrated, the multifunction machine 10, etc., to output its own apparatus setting as export data, on the basis of an export instruction output from the terminal apparatus 30, for example. Here, an example of the processing is explained in which, in an attempt by the multifunction machine 10 to restore its own apparatus setting, the apparatus setting is transmitted to the terminal apparatus 30 as export data.

First, the controller 11 reads a setting value of the apparatus setting stored in the apparatus setting storage area 196 (step S10).

Next, the controller 11 encodes the setting value having been read (step S12). In the first embodiment, the controller 11 represents the apparatus setting in tags as a format, and performs encoding in an XML format in which the setting values are inserted among the tags.

The controller 11 determines whether all the setting values relating to the targeted apparatus setting have been read (step S14). If determining that all the setting values relating to the targeted apparatus setting have been read, the controller 11 assigns a header portion to a data portion relating to the setting values, thereby generating encoded data (step S14; Yes→step S16). On the other hand, if determining that not all the setting values relating to the targeted apparatus setting have been read, the controller 11 continues reading the setting values (step S14; No→step S10).

Then, the controller 11 transmits the generated encoded data to the terminal apparatus 30 as export data, and ends the processing (step S18).

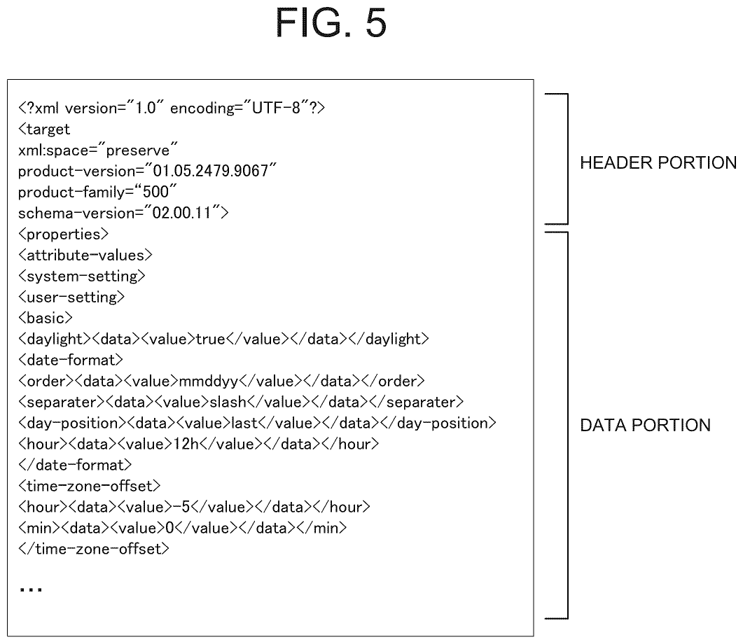

Here, an exemplary configuration of export data which can be generated in the flowchart of FIG. 4 is described with reference to FIG. 5. The export data in FIG. 5 is generated in an XML format, and is configured by a header portion and a data portion. The header portion includes the data version and basic information about the generated apparatus. On the other hand, the data portion includes the data resulting from encoding the setting value of the setting item in the XML format.

For example, in the “time-zone-offset”, which is an example of a setting item, the setting value “−5” for “time<hour>” can be represented by inserting the setting value “−5” into child tags <hour><data><value></value>/<data></hour>belonging to parent tags (<time-zone-offset></time-zone-offset>) representing the setting item.

Next, processing to import export data, as illustrated in FIG. 5, etc., as import data is described. In the first embodiment, the following four modes are described, as import processing in the case where OAuth authentication information relating to OAuth authentication is included in the import data as an authentication method requiring prior authorization.

(Mode 1) Rewriting of the apparatus authentication information with the OAuth authentication information is omitted, and the user is notified that rewriting of the apparatus authentication information is omitted.

(Mode 2) Before rewriting the apparatus authentication information with the OAuth authentication information, an inquiry is issued to the user and selection by the user is obtained as to whether to rewrite the apparatus authentication information.

(Mode 3) Before and after rewriting the apparatus authentication information with the OAuth authentication information, the user is informed that reauthorization in the OAuth authentication method is required.

(Mode 4) After duplication of the apparatus authentication information, the apparatus authentication information is rewritten with the OAuth authentication information, and the user's selection is received as to whether to reset the authentication setting, on the basis of the apparatus authentication information rewritten with the OAuth authentication information or to restore the rewritten apparatus authentication information to the original state.

### 1.3.2. Import Processing Relating to Mode 1

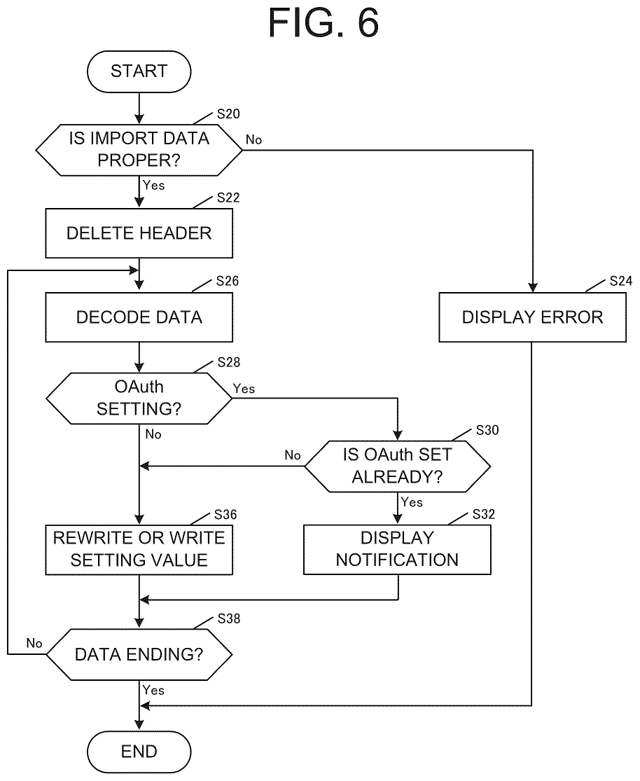

FIG. 6 is a flowchart for explaining import processing relating to mode 1. Note that the following processing described with reference to FIG. 6 to FIG. 10 is processing executed by the controller 11 of the multifunction machine 10 by reading the web program 193, the import data verification program 194, the apparatus setting management program 195, or the like.

First, the controller 11 determines whether the import data input as import data is proper (step S20). For example by verifying whether the input import data is in an XML format and whether the import data is constituted by a header portion and a data portion, the controller 11 can determine whether the import data is proper. If determining that the import data is proper, the controller 11 deletes the header portion from the import data (step S20; Yes→step S22). On the other hand, if determining that the import data is not proper, the controller 11 displays an error notification on the display 13, and ends the processing (step S20; No→step S24).

After deleting the header portion from the import data, the controller 11 decodes the data portion of the import data (step S26). Note that, as described earlier, the data portion is described in an XML format, and the setting value may be encrypted. The controller 11 decodes the data of the data portion, and determines to which apparatus setting the decoded setting value relates (in this example, to which OAuth authentication information the decoded setting value relates) (step S28).

If determining that the decoded setting value relates to the OAuth authentication information, the controller 11 determines whether apparatus authentication information is included in the existing apparatus setting, and whether that apparatus authentication information corresponds to the OAuth authentication information (step S28; Yes→step S30). That is, the controller 11 determines whether the existing apparatus setting relating to authentication of the multifunction machine 10 is set to the OAuth authentication. If determining that the existing apparatus authentication information corresponds to the OAuth authentication information, the controller 11 omits (skips) rewriting of the existing apparatus authentication information by OAuth authentication information, and a notification screen indicating that no rewriting has been performed is displayed (step S30; Yes→step S32). On the other hand, if the existing apparatus authentication information does not correspond to the OAuth authentication information, but corresponds to the SMTP authentication, for example (step S30; No), or if the decoded setting value does not relate to the OAuth authentication information (step S28; No), the controller 11 rewrites or writes the setting value relating to the apparatus setting, with or as the decoded setting value (step S36).

Then, the controller 11 determines whether decoding of all the setting values is ended (step S38). If determining that decoding of all the setting values is ended, the controller 11 ends the processing (step S38; Yes→END). On the other hand, if not determining that decoding of all the setting values is ended, the controller 11 returns the processing to step S26 (step S38; No →step S26).

### 1.3.3. Import Processing Relating to Mode 2

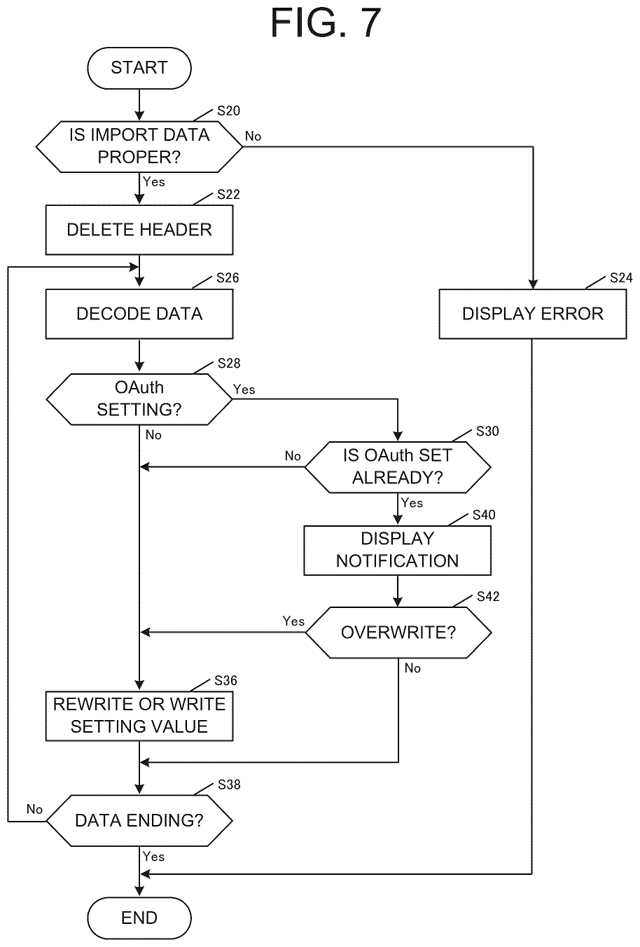

FIG. 7 is a flowchart for explaining import processing relating to mode 2. Note that the processing which can be the same processing as explained with reference to FIG. 6 is assigned the same step numeral, and the explanation thereof is omitted.

In step S30, if determining that the existing apparatus authentication information corresponds to the OAuth authentication information, the controller 11 displays a notification screen to the user inquiring whether to rewrite the existing apparatus authentication information with the OAuth authentication information (step S30; Yes→step S40). If having received an overwrite instruction for the apparatus authentication information from the user having checked the notification screen, the controller 11 overwrites that apparatus authentication information by rewriting it with the OAuth authentication information (step S42; Yes→step S36). On the other hand, if not having received an overwrite instruction for the apparatus authentication information from the user having checked the notification screen, the controller 11 does not rewrite the existing apparatus authentication information with the OAuth authentication information, and proceeds to step S38 (step S42; No→step S38).

### 1.3.4. Import Processing Relating to Mode 3

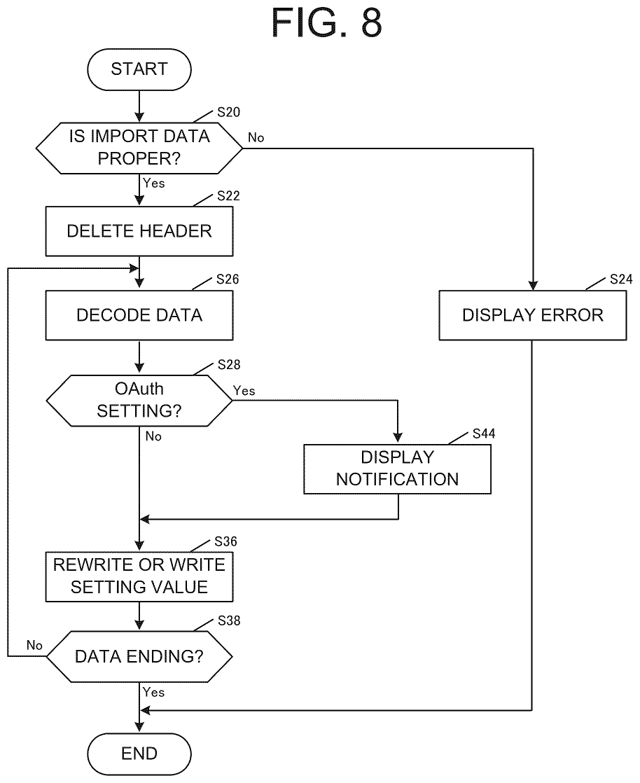

FIG. 8 is a flowchart for explaining import processing relating to mode 3, and explains a mode in which a notification is issued to inform that reauthorization of the OAuth authentication is required before rewriting of the apparatus authentication information with the OAuth authentication information. Note that the processing which can be the same processing as explained with reference to FIG. 6 is assigned the same step numeral, and the explanation thereof is omitted.

In step S28, the controller 11 determines whether the decoded setting value relates to the Auth authentication information. If determining that the decoded setting value relates to the OAuth authentication information, the controller 11 notifies that reauthorization processing relating to the OAuth authentication is required (step S28; Yes→step S44). Then, the controller 11 overwrites that apparatus authentication information by rewriting the existing apparatus authentication information with the OAuth authentication information (step S36). On the other hand, if determining that the decoded setting value does not relate to the OAuth authentication information, the controller 11 rewrites or writes the setting value relating to the apparatus setting, with or as the decoded setting value (step S28; No→step S36).

Then, the controller 11 determines whether decoding of all the setting values is ended (step S38). If determining that decoding of all the setting values is ended, the controller 11 ends the processing (step S38; Yes→END). On the other hand, if not determining that decoding of all the setting values is ended, the controller 11 returns the processing to step S26 (step S38; No→step S26).

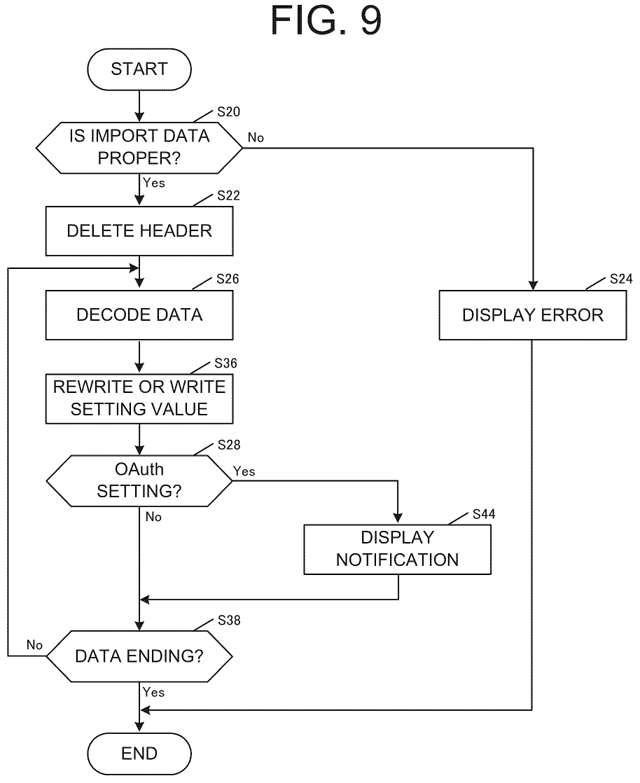

FIG. 9 is a flowchart for explaining import processing relating to mode 3, and explains a mode in which a notification is issued to inform that reauthorization of the OAuth authentication is required after rewriting of the apparatus authentication information with the OAuth authentication information. Note that the processing which can be the same processing as explained with reference to FIG. 8 is assigned the same step numeral, and the explanation thereof is omitted.

In step S26, the controller 11 rewrites or writes the decoded setting value (step S36). Then, the controller 11 determines whether the rewritten or written setting value relates to the OAuth authentication information (step S28). If determining that the rewritten or written setting value relates to the OAuth authentication information, the controller 11 notifies that reauthorization processing relating to the OAuth authentication is required (step S28; Yes→step S44).

The controller 11 determines whether decoding of all the setting values is ended (step S38). If determining that decoding of all the setting values is ended, the controller 11 ends the processing (step S38; Yes→END). On the other hand, if not determining that decoding of all the setting values is ended, the controller 11 returns the processing to step S26 (step S38; No→step S26). Note that if determining that the rewritten or written setting value does not relate to the OAuth authentication information in step S28, the controller 11 executes the processing in and after step S38 (step S28; No→step S38).

### 1.3.5. Import Processing Relating to Mode 4

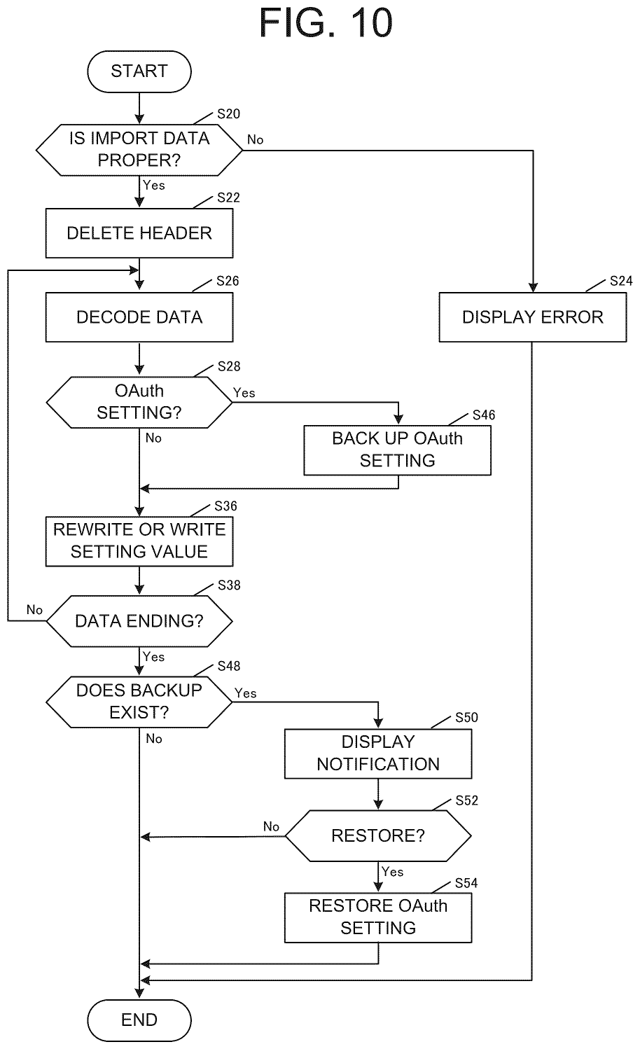

FIG. 10 is a flowchart for explaining import processing relating to mode 4. Note that the processing which can be the same processing as explained with reference to FIG. 6 to FIG. 9 is assigned the same step numeral, and the explanation thereof is omitted. Note that the explanation relating to mode 4 assumes that the existing apparatus authentication information corresponds to the OAuth authentication information.

In step S28, the controller 11 determines whether the decoded setting value relates to the OAuth authentication information. If determining that the decoded setting value relates to the OAuth authentication information, the controller 11 backs up the OAuth setting as the existing apparatus authentication information, and rewrites it with the OAuth authentication information which is the decoded setting value, thereby overwriting that apparatus authentication information (step S28; Yes→step S46→step S36).

Note that if determining that the decoded setting value does not relate to the OAuth authentication information, the controller 11 rewrites or writes the decoded setting value in step S26 (step S28; No→step S36). Then, the controller 11 determines whether decoding of all the setting values is ended (step S38). If determining that decoding of all the setting values is ended, the controller 11 determines whether there is a backup of the OAuth setting (step S38; Yes→step S48). Note that if determining that decoding of all the setting values is not ended, the controller 11 returns the processing to step S26 (step S38; No→step S26).

If determining that there is a backup of the OAuth setting, the controller 11 displays a notification screen to inquire the user whether to reset the authentication setting, on the basis of the apparatus authentication information rewritten with the OAuth authentication information or to return (restore) the rewritten apparatus authentication information to the original state using the backup (step S48; Yes→step S50).

Subsequently, the controller 11 determines whether a restore instruction instructing restoration using the backup of the apparatus authentication information is received from the user having checked the notification screen (step S52). If determining that the restore instruction is received, the controller 11 restores the rewritten apparatus authentication information (OAuth setting) using the backup (step S52; Yes→step S54).

Note that if there is no backup of the OAuth setting (step S48; No), or if the restore instruction instructing restoration using the backup is not received (step S52; No), the controller 11 ends the processing.

### 1.4. Operation Example

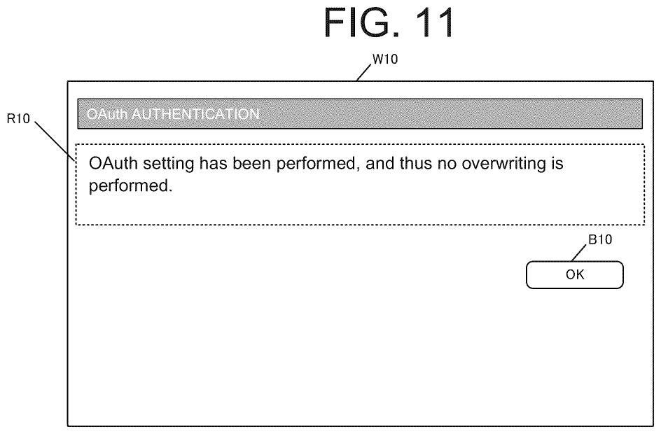

Next, an operation example according to the first embodiment is described. FIG. 11 is a diagram for explaining an exemplary display configuration of a notification screen W10 to be presented to a user in step S32 (FIG. 6) in the import processing relating to mode 1.

The notification screen W10 includes a message display area R10 and an OK button B10. The message display area R10 is a display area to display notification content indicating “OAuth setting has been performed, and thus no overwriting is performed.”, for example, to inform that rewriting of the existing apparatus authentication information with the OAuth authentication information is omitted (skipped). The OK button B10 is a button to receive the user's instruction of confirmation to the content displayed in the message display area R10. When the user selects the OK button B10, the controller 11 finishes display of the notification screen W10.

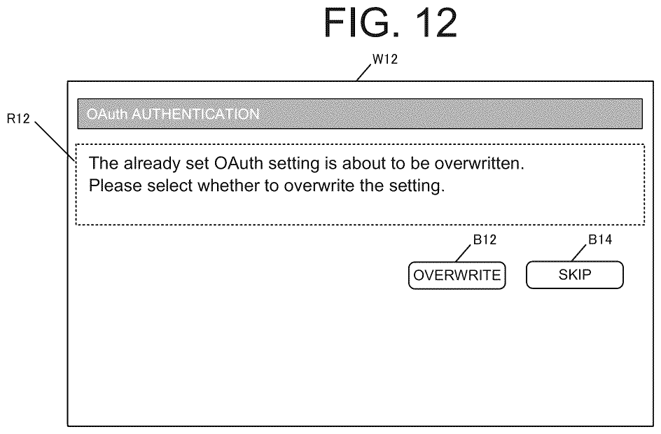

FIG. 12 is a diagram for explaining an exemplary display configuration of a notification screen W12 to be presented to a user to inquire whether to rewrite (overwrite) the existing apparatus authentication information with the OAuth authentication information, in step S40 (FIG. 7) in the import processing relating to mode 2.

The notification screen W12 includes a message display area R12, an overwrite button B12, and a skip button B14. The message display area R12 is a display area to display notification content indicating “The already set OAuth setting is about to be overwritten. Please select whether to overwrite the setting.”, for example, to inquire the user whether to rewrite and overwrite the existing apparatus authentication information with the OAuth authentication information. The overwrite button B12 is a button to receive the user's selection of the overwrite instruction for the existing apparatus authentication information. When having received the selection instruction for the overwrite button B12, the controller 11 overwrites that apparatus authentication information by rewriting the existing apparatus authentication information with the OAuth authentication information. The skip button B14 is a button to receive a skip instruction for the overwrite instruction for the existing apparatus authentication information. When having received the selection instruction for the skip button B14, the controller 11 finishes display of the notification screen W12 without overwriting the existing apparatus authentication information with the OAuth authentication information. Note that, at this time, information other than the OAuth setting may be overwritten with the import data, or the import data may be written therefor.

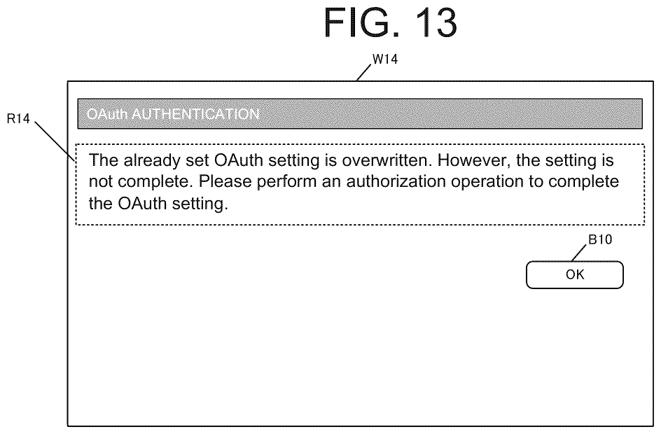

FIG. 13 is a diagram for explaining an exemplary display configuration of a notification screen W14 to notify that, after rewriting (overwriting) of the apparatus authentication information with the OAuth authentication information, reauthorization of the OAuth authentication is required, in step S44 (FIG. 9) in the import processing relating to mode 3.

The notification screen W14 includes a message display area R14 and an OK button B10. The message display area R14 is a display area to display notification content indicating “The already set OAuth setting is overwritten. However, the setting is not complete. Please perform an authorization operation to complete the OAuth setting.”, for example, to inform that reauthorization of the OAuth authentication is required after rewriting (overwriting) of the apparatus authentication information with the OAuth authentication information. The OK button B10 is a button to receive the user's instruction of confirmation to the content displayed in the message display area R14. When the user selects the OK button B10, the controller 11 finishes display of the notification screen W14. Note that, so as to inform that reauthorization of the OAuth authentication is required before rewriting (overwriting) of the apparatus authentication information with the OAuth authentication information, a notification can be displayed on the message display area R14, as having such notification content as “The already set OAuth setting is about to be overwritten. However, that alone will not complete the setting. Please perform an authorization operation to complete the OAuth setting.”, for example. By the way, the notification screen W14 may include a button to receive a screen transition instruction to transition to an authorization operation screen.

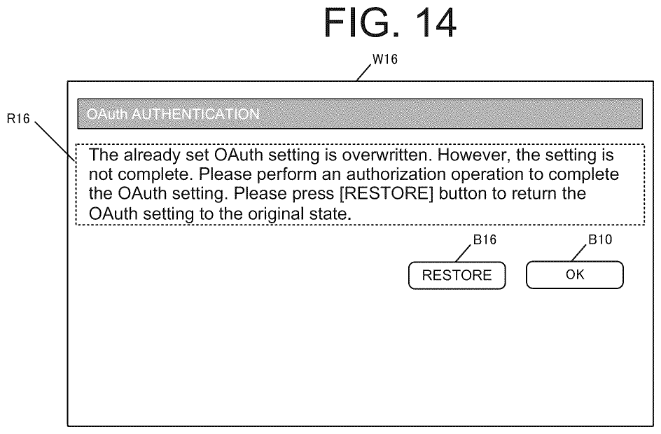

FIG. 14 is a diagram for explaining an exemplary display configuration of a notification screen W16 to inquire whether to reset the authentication setting, on the basis of the apparatus authentication information rewritten (overwritten) with the OAuth authentication information or to return the rewritten (overwritten) apparatus authentication information to the original state using the backup, in step S50 (FIG. 10) in the import processing relating to mode 4.

The notification screen W16 includes a message display area R16, a restore button B16, and an OK button B10. The message display area R16 is a display area to display notification content indicating “The already set OAuth setting is overwritten. However, the setting is not complete. Please perform an authorization operation to complete the OAuth setting. Please press [RESTORE] button to return the OAuth setting to the original state.”, for example, to inquire whether to reset the authentication setting, on the basis of the apparatus authentication information rewritten (overwritten) with the OAuth authentication information or to return the rewritten (overwritten) apparatus authentication information to the original state using the backup. The restore button B16 is a button to receive the user's selection of the restore instruction involving the backup of the apparatus authentication information. When having received the selection instruction for the restore button B16, the controller 11 restores the rewritten (overwritten) apparatus authentication information (OAuth setting) using the backup. The OK button B10 is a button to receive the user's instruction of confirmation to the content displayed in the message display area R16. When the user selects the OK button B10, the controller 11 finishes display of the notification screen W16.

As described so far, according to the first embodiment, any of the following four modes can be taken as the import processing in the case where OAuth authentication information relating to OAuth authentication is included in the import data.

(Mode 1) Rewriting of the apparatus authentication information with the OAuth authentication information is omitted, and the user is notified that rewriting of the apparatus authentication information is omitted.

(Mode 2) Before rewriting the apparatus authentication information with the OAuth authentication information, an inquiry is issued to the user and selection by the user is obtained as to whether to rewrite the apparatus authentication information.

(Mode 3) Before and after rewriting the apparatus authentication information with the OAuth authentication information, the user is informed that reauthorization in the OAuth authentication method is required.

(Mode 4) After duplication of the apparatus authentication information, the apparatus authentication information is rewritten with the OAuth authentication information, and the user's selection is received as to whether to reset the authentication setting, on the basis of the apparatus authentication information rewritten with the OAuth authentication information or to restore the rewritten apparatus authentication information to the original state. According to the above-described configuration, the user can understand the import status of the setting relating to the OAuth authentication, the necessity to acquire the token, etc., and therefore resetting relating to the OAuth authentication can be easily performed in the processing apparatus which is the import destination. In addition, the existing apparatus setting rewritten (overwritten) with the import data can be easily returned to the original state, which helps provide a highly convenient resetting method of authentication setting.

### 2. Second Embodiment

A second embodiment issues a reauthorization request to an account holder, in addition to a notification to inform that reauthorization of the OAuth authentication is required after rewriting of the apparatus authentication information, in the import processing relating to mode 3, as illustrated in FIG. 9, FIG. 13, or the like, according to the first embodiment.

A functional configuration and a flow of processing of a multifunction machine, or the like, according to the second embodiment are substantially the same as those in the first embodiment, and therefore description thereof is omitted here.

### 2.1. Operation Example

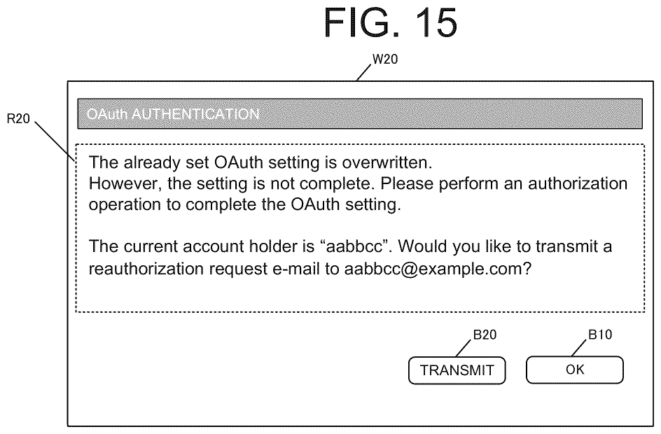

FIG. 15 is a diagram for explaining an operation example according to the second embodiment. The notification screen W20 illustrated in FIG. 15 includes a message display area R20, a transmit button B20, and an OK button B10. The message display area R20 is a display area to display notification content indicating “The already set OAuth setting is overwritten. However, the setting is not complete. Please perform an authorization operation to complete the OAuth setting. The current account holder is “aabbcc”. Would you like to transmit a reauthorization request e-mail to aabbcc@example.com?”, for example, to inform that reauthorization of the OAuth authentication is required after rewriting of the apparatus authentication information with the OAuth authentication information, and to inquire whether to transmit a reauthorization request e-mail to the account holder. The transmit button B20 is a button to receive the user's transmission instruction for the reauthorization request e-mail. When the transmit button B20 is selected, the controller 11 transmits an e-mail requesting reauthorization of the OAuth authentication, to the contact address aabbcc@example.com of “aabbcc”. The OK button B10 is a button to receive the user's instruction of confirmation to the content displayed in the message display area R20. When the user selects the OK button B10, the controller 11 finishes display of the notification screen W20.

Note that in the second embodiment, the configuration to issue a reauthorization request to an account holder via e-mail is described. However, other communication means can be used, such as via telephone, short message service (SMS), or facsimile transmission, as long as they are capable of issuing a reauthorization request to an account holder.

As described so far, the second embodiment can transmit a reauthorization request notification to an account holder, in addition to having the effect according to the first embodiment. By having such a configuration, the user's labor relating to the reauthorization can be alleviated in the processing apparatus which is the import destination.

### 3. Third Embodiment

A third embodiment is an embodiment in which, when the decoded setting value is determined to relate to the OAuth authentication information in the first embodiment, the setting value is stored, and then the existing apparatus authentication information is rewritten (overwritten) with the OAuth authentication information after decoding of all the setting values included in the import data is ended.

A functional configuration and a flow of processing of a multifunction machine, or the like, according to the third embodiment are substantially the same as those in the first embodiment, and therefore description thereof is omitted here.

### 3.1. Flow of Processing

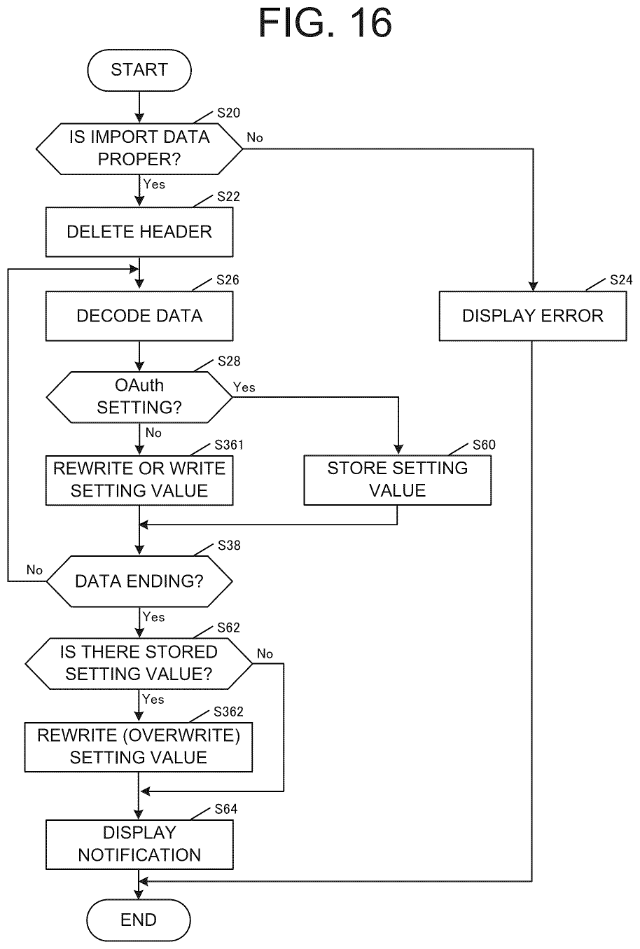

FIG. 16 is a flowchart for explaining a flow of processing according to a third embodiment. Note that the processing which can be the same processing as explained with reference to any of FIG. 6 to FIG. 10 is assigned the same step numeral, and the explanation thereof is omitted.

In step S28, the controller 11 determines whether the decoded setting value relates to the OAuth authentication information. When determining that the decoded setting value relates to the OAuth authentication information, the controller 11 stores that setting value in the apparatus setting storage area 196 (authentication information storage area 1961) (step S28; Yes→step S60). On the other hand, when determining that the decoded setting value does not relate to the OAuth authentication information, the controller 11 rewrites or writes the setting value relating to the apparatus setting, with or as the decoded setting value (step S28; No→step S361).

Then, the controller 11 determines whether decoding of all the setting values is ended (step S38). If determining that decoding of all the setting values is ended, the controller 11 determines whether there is a setting value stored in the apparatus setting storage area 196 (authentication information storage area 1961) (step S38; Yes→step S62).

If determining that there is a setting value stored in the apparatus setting storage area 196 (authentication information storage area 1961), the controller 11 rewrites (overwrites), with that setting value, the setting value relating to the corresponding apparatus authentication information (step S62; Yes→step S362). Then, the controller 11 displays, on the notification screen, a message indicating that the existing apparatus authentication information has been rewritten (overwritten) with the OAuth authentication information, and ends the processing (step S64). On the other hand, if determining that there is no setting value stored in the apparatus setting storage area 196 (authentication information storage area 1961), the controller 11 skips step S362, and displays, on the notification screen, a message indicating that the existing apparatus authentication information has not been rewritten (overwritten) with the OAuth authentication information, and ends the processing (step S64).

### 3.2. Operation Example

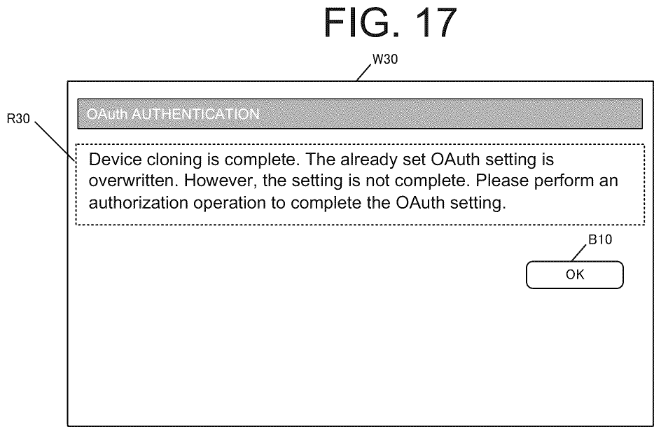

FIG. 17 is a diagram for explaining an operation example according to the third embodiment. The notification screen W30 illustrated in FIG. 17 includes a message display area R30 and an OK button B10. The message display area R30 is a display area to display notification content indicating “Setting of the device cloning is complete. The already set OAuth setting is overwritten. However, the setting is not complete. Please perform an authorization operation to complete the OAuth setting.”, for example, to inform completion of the device cloning and that although the apparatus authentication information is rewritten with the OAuth authentication information, reauthorization of the OAuth authentication is required. The OK button B10 is a button to receive the user's instruction of confirmation to the content displayed in the message display area R30. When the user selects the OK button B10, the controller 11 finishes display of the notification screen W30. By the way, the notification screen W30 may include a button to receive a transmission instruction to transmit a reauthorization request e-mail directed to the account holder.

Note that in the third embodiment, the configuration is described, in which, if a setting value relating to the OAuth authentication information is stored in the apparatus setting storage area 196 (authentication information storage area 1961), the setting value relating to the corresponding apparatus authentication information is rewritten (overwritten) with that setting value. However, if the existing apparatus setting relating to authentication of the multifunction machine 10 is set to the OAuth authentication, the rewriting (overwriting) of the setting value relating to the apparatus authentication information may be omitted, and a notification to the effect that the rewriting (overwriting) is omitted may be notified to the user.

As described so far, in addition to the effect of the first embodiment, the third embodiment has such a configuration that, after decoding of all the setting values included in the import data is ended, rewriting (overwriting) of the existing apparatus authentication information with the OAuth authentication information is performed. Therefore, any import delay of the setting values of the apparatus setting, other than those related to the OAuth authentication, can be prevented, which is attributed to confirmation failure of the notification screen relating to the OAuth authentication, for example.

### 4. Modification Example

The present disclosure is not limited to each embodiment described above, and various modifications can be made. That is, such embodiments obtained by combining the technical means modified as necessary within the scope not depart from the spirit of the present disclosure are included in the technical scope of the present disclosure.

In addition, some parts of the above-described embodiments are described separately from each other, for the purpose of description, however, needless to say, these parts may be executed in combination within the technically possible scope.

In addition, programs operated in each apparatus in the embodiments are programs (programs causing the computer to function) that control the CPU, or the like, to realize the above-described functions of the embodiments. The information dealt with in these apparatuses is temporarily stored in the temporary storage device (e.g., RAM) at the time when the information is processed, is thereafter stored in various storage devices such as read only memory (ROM) and HDD, and is read, modified, or written, by means of the CPU, as necessary.

Here, examples of the recording medium to store the programs include semiconductor media (e.g., ROM or nonvolatile memory cards, optical recording media, magneto-optical recording media (e.g., digital versatile discs (DVD), magneto optical discs (MO), mini discs (MD), compact discs (CD), Blu-ray (registered trademark) (BD) discs), magnetic recording media (e.g., magnetic tape, flexible disks). In addition, not only the functions of the embodiments, which are described above, are realized by execution of the loaded programs, but also the functions of the present disclosure may be executed as a result of the instruction given by the programs causing the operating system or any other application program to jointly perform the processing.

When put in the market, the programs may be stored in portable recording media, or transferred to server computers connected via a network such as the Internet. In such cases, the storage devices of the server computers are, needless to say, included in the present disclosure.

Moreover, each functional block or various features of the apparatuses used in the above-described embodiments may also be implemented or executed by electric circuitry, such as an integrated circuit or a plurality of integrated circuits. The electric circuitry designed to realize the functions described in the present specification may include general-purpose processors, digital signal processors (DSP), application specific integrated circuits (ASIC), field programmable gate arrays (FPGA), or any other programmable logic devices, discrete gates or transistor logics, discrete hardware components, or any combination of them. The general-purpose processors may be microprocessors, or may be conventional processors, controllers, microcontrollers, or state machines. The above-mentioned electric circuitry may be configured by digital circuits, or may be configured by analog circuits. If any technology to integrate circuits to replace the current integrated circuits due to advancement of semiconductor technologies, one or more modes of the present disclosure may use such novel integrated circuits using such technologies.

What is claimed is:

1. A processing apparatus comprising:
one or more memories that store an apparatus setting including authentication information; and
one or more controllers that verify import data imported to an apparatus and collectively rewrite, with the import data, the apparatus setting stored in the one or more memories, wherein
as a result of the verification of the import data, when it is determined that the import data includes a related setting relating to an authentication method requiring prior authorization, and that the related setting corresponds to the authentication information, the one or more controllers reset an authentication setting by controlling rewriting of the authentication information with the related setting.

2. The processing apparatus according to claim 1, wherein
the one or more controllers omit the rewriting of the authentication information with the related setting, and notify a user that rewriting of the authentication information is omitted.

3. The processing apparatus according to claim 1, wherein
the one or more controllers issue an inquiry to a user whether or not to rewrite the authentication information before the rewriting of the authentication information with the related setting, and receive the user's selection as to whether to rewrite the authentication information.

4. The processing apparatus according to claim 1, wherein
the one or more controllers notify a user that reauthorization in the authentication method is required before and after the rewriting of the authentication information with the related setting.

5. The processing apparatus according to claim 1, wherein
the one or more controllers rewrite the authentication information after duplication of the authentication information, and receive a user's selection as to whether to reset the authentication setting, on the basis of the authentication information rewritten with the related setting, or to return the rewritten authentication information to an original state.

6. The processing apparatus according to claim 4, wherein
the one or more controllers notify a holder of the authentication information that reauthorization of the authentication method is required.

7. The processing apparatus according to claim 1, wherein
the one or more controllers reset the authentication setting after collectively rewriting the apparatus setting with the import data.

8. An image processing apparatus comprising:
a processing apparatus including
one or more memories that store an apparatus setting including authentication information; and
one or more controllers that verify import data imported to an apparatus and collectively rewrite, with the import data, the apparatus setting stored in the one or more memories, where
as a result of the verification of the import data, when it is determined that the import data includes a related setting relating to an authentication method requiring prior authorization, and that the related setting corresponds to the authentication information, the one or more controllers reset an authentication setting by controlling rewriting of the authentication information with the related setting; and
an image processor that performs image processing, on the basis of the apparatus setting rewritten with the import data.

9. An import data processing method, comprising:
storing an apparatus setting including authentication information;
verifying import data imported to an apparatus and collectively rewriting, with the import data, the apparatus setting having been stored; and
as a result of the verification of the import data, when it is determined that the import data includes a related setting relating to an authentication method requiring prior authorization, and that the related setting corresponds to the authentication information, resetting an authentication setting by controlling rewriting of the authentication information with the related setting.
